(19) United States
(12) Patent Application Publication
(10) Pub. No.: US 2012/0042098 A1
(43) Pub. Date: Feb. 16, 2012

(54) Method and Apparatus for Implementing Address Privacy in Communications Networks

(75) Inventors: Mika Ilkka Tapani Kasslin, Espoo (FI); Jan-Erik Gustav Ekberg, Vanda (FI); Miika Laaksonen, Espoo (FI)

(73) Assignee: NOKIA CORPORATION, Espoo (FI)

(21) Appl. No.: 13/263,986

(22) PCT Filed: Apr. 9, 2009
(86) PCT No.: PCT/US2009/040084

§ 371 Date: Oct. 11, 2011

(51) Int. Cl. G06F 15/16

(52) U.S. Cl. 709/245

(57) ABSTRACT

Various methods for implementing address privacy in communications networks are provided. One method may include receiving a lower layer address block. The lower layer address block may include a random component and a lower layer solution component. The random component may include a random value and the lower layer solution component may be based at least in part on the random value and a shared key. The method may also include verifying the lower layer address block via the random value and the shared key. The method may further include receiving a higher layer address block. The higher layer address block may include a higher layer solution component. The higher layer solution component may be based at least in part on the random value and a shared key. The method may further include verifying the higher layer address block via the random value and the shared key. Similar apparatuses and computer program products are also provided.

### TECHNICAL FIELD

Embodiments of the present invention relate generally to network communications, and, more particularly, relate to a method and apparatus for implementing address privacy in a communications network.

### BACKGROUND

The modern communications era has brought about a tremendous expansion of wireline and wireless networks. Various types of networking technologies have been developed resulting in unprecedented expansion of computer networks, television networks, telephony networks, and the like, fueled by consumer demand. Advances in networking technology have allowed users of electronic devices to maintain network connectivity, even when in transit. Wireless and mobile networking technologies have addressed related consumer demands, while providing more flexibility and immediacy of information transfer.

As networks become increasingly interconnected to more devices, users find themselves increasingly dependent upon the devices connected to the networks. As such, many users rarely part from their communications devices in order to maintain their availability to co-workers and friends, and keep current with any new events that may arise. While maintaining a level of connectivity to the network can prove useful for a number of reasons, the use of connected devices can also raise privacy concerns. For example, a cellular telephone may be continuously connected to its accessories over a network, and as such, information about the user of the cellular telephone may be obtained by monitoring the activities of the phone. Further, as networking technology advances, more devices may be networked at the user level increasing a user's exposure to potential privacy issues. Many network technologies utilize static and repeated addressing for devices connected to the network. These and other types of network technologies may expose users to a variety of privacy risks as a result of the addressing scheme.

### BRIEF SUMMARY

Methods and apparatus are described that implement address privacy in communications networks. Via address privacy mechanisms described herein, example embodiments of the present invention introduce anonymity to the addressing used between communications devices. Various example embodiments introduce address privacy in a manner that allows for implementation of the embodiments without modification to existing communication standards. To do so, various example embodiments generate and resolve addressing via a random value and a shared key.

An advertising device (a device wishing to connect with another device or a network) may be configured to generate a lower layer address block for transmission to a resolving device (a device configured to verify the identification of an advertising device and open a communications connection). The lower layer address block may be generated to include a random component and a lower layer solution component. The random component may include a random value, and the lower layer solution component may include a first result of an evaluation of a one-way function using the random value and a shared key as inputs to the function. The lower layer address block may be communicated to the resolving device to facilitate opening a connection at the lower layer (e.g., the link layer). The resolving device may verify the address block by independently determining the first result of the one-way function using the random value (taken from the lower layer address block) and the shared key. Upon verification, a lower level connection may be opened.

The advertising device may subsequently, or in parallel, generate a higher layer address block. The higher layer address block may be communicated to the resolving device to facilitate opening a connection at the higher layer (e.g., the network layer). The higher layer address block may include a higher layer solution component including a second result (e.g., a recursive result) of the one-way function based on the shared key and the first result of the one-way function. The resolving device may verify the higher layer address block by independently determining the second result of the one-way function.

As a result, example embodiments of the present invention provide address privacy due to the inclusion of a random value in the lower layer and higher layer address blocks. Example embodiments also provide multi-layer address privacy since the random value used to verify the address block at the lower layer is reused to formulate the address block for the higher layer. Where dynamic addressing is supported on the higher layer (e.g., Internet Protocol (IP) layer), a resolving device may increasingly assure the identity of the advertising device, while maintaining anonymity, by renewing the higher layer address block with recursive results of the one-way function based on the random value and the shared key. In this manner, example embodiments of the present invention may modify the higher layer address in a predictable manner to a device having the shared key, but to an on-looking third party device, the changes in the address may appear to be random.

Various example embodiments of the present invention are described herein. One example embodiment is a method for implementing address privacy. The example method includes receiving a lower layer address block from an advertising device. The lower layer address block may include a random component and a lower layer solution component. The random component including a random value and the lower layer solution component may be based at least in part on the random value and a shared key. The example method may further include verifying the lower layer address block via the random value and the shared key and receiving a higher layer address block from the advertising device. The higher layer address block may include a higher layer solution component. The higher layer solution component may be based at least in part on the random value and a shared key. The example method may further include verifying the higher layer address block via the random value and the shared key.

Another example embodiment is an example apparatus for implementing address privacy. The example apparatus comprises a processor and a memory storing instructions that, in response to execution of the instructions by the processor, cause the example apparatus to perform various functions. The example apparatus may be caused to receive a lower layer address block from an advertising device. The lower layer address block may include a random component and a lower layer solution component. The random component including a random value and the lower layer solution component may be based at least in part on the random value and a shared key. The example apparatus may be further caused to verify the lower layer address block via the random value and the shared key and receive a higher layer address block from the advertising device. The higher layer address block may include a higher layer solution component. The higher layer solution component may be based at least in part on the random value and a shared key. The example apparatus may be further caused to verify the higher layer address block via the random value and the shared key.

Another example embodiment is an example computer program product for implementing address privacy. The example computer program product comprises at least one computer-readable storage medium having executable computer-readable program code instructions stored therein. The computer-readable program code instructions of the example computer program product are configured to receive a lower layer address block from an advertising device. The lower layer address block may include a random component and a lower layer solution component. The random component including a random value and the lower layer solution component may be based at least in part on the random value and a shared key. The computer program product may be further configured to verify the lower layer address block via the random value and the shared key and receive a higher layer address block from the advertising device. The higher layer address block may include a higher layer solution component. The higher layer solution component may be based at least in part on the random value and a shared key. The computer-readable program code instructions may be further configured to verify the higher layer address block via the random value and the shared key.

Yet another example embodiment is an apparatus for implementing address privacy. The example apparatus includes means for receiving a lower layer address block from an advertising device. The lower layer address block may include a random component and a lower layer solution component. The random component including a random value and the lower layer solution component may be based at least in part on the random value and a shared key. The example apparatus may further include means for verifying the lower layer address block via the random value and the shared key and means for receiving a higher layer address block from the advertising device. The higher layer address block may include a higher layer solution component. The higher layer solution component may be based at least in part on the random value and a shared key. The example apparatus may further include means for verifying the higher layer address block via the random value and the shared key.

### BRIEF DESCRIPTION OF THE DRAWING(S)

Having thus described the invention in general terms, reference will now be made to the accompanying drawings, which are not necessarily drawn to scale, and wherein:

FIG. 1 illustrates a signaling diagram for implementing address privacy according to various example embodiments of the present invention;

FIG. 2a illustrates an example of higher layer and lower layer address blocks according to various example embodiments of the present invention;

FIG. 2b illustrates an example of higher layer and lower layer address blocks according to various example embodiments of the present invention;

FIG. 3 illustrates a block diagram of an apparatus for implementing address privacy according to various example embodiments of the present invention;

FIG. 4a illustrates a flowchart of an example of a method for implementing address privacy according to various example embodiments of the present invention; and

FIG. 4b illustrates a flowchart of an example of a method for implementing address privacy according to various example embodiments of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

The term “random” may be used, according to some example embodiments of the present invention, to refer to purely random values or pseudo-random values determined via an algorithm. The phrase “one-way function” may be used, according to some example embodiments of the present invention, to refer to a function that is computable for a result when each input is known, but an inversion of the function based on the result is difficult to compute. Examples of one-way functions or aspects of one-way functions may include integer factorization, Rabin functions, discrete logarithms, and the like. The term “one-way function” may also be used, according to some example embodiments of the present invention, to refer to trapdoor one-way functions.

Various example embodiments of the present invention implement address privacy to, for example, avoid the possibility of being tracked or other targeting via an address. In this regard, a random value generator may be implemented and a resultant random value, together with a shared key, may be utilized to implement address privacy. Example embodiments of the present invention also reduce the possibility of identity confusion due to random address collisions (e.g., situations where two separate devices acquire the same random address) by providing mechanisms for increasingly assuring the identity of a device, while maintaining anonymity with respect to other devices. Example embodiments of the present invention may effectively increase the number of bits associated with an address of a device, to thereby reduce the probability of such collisions.

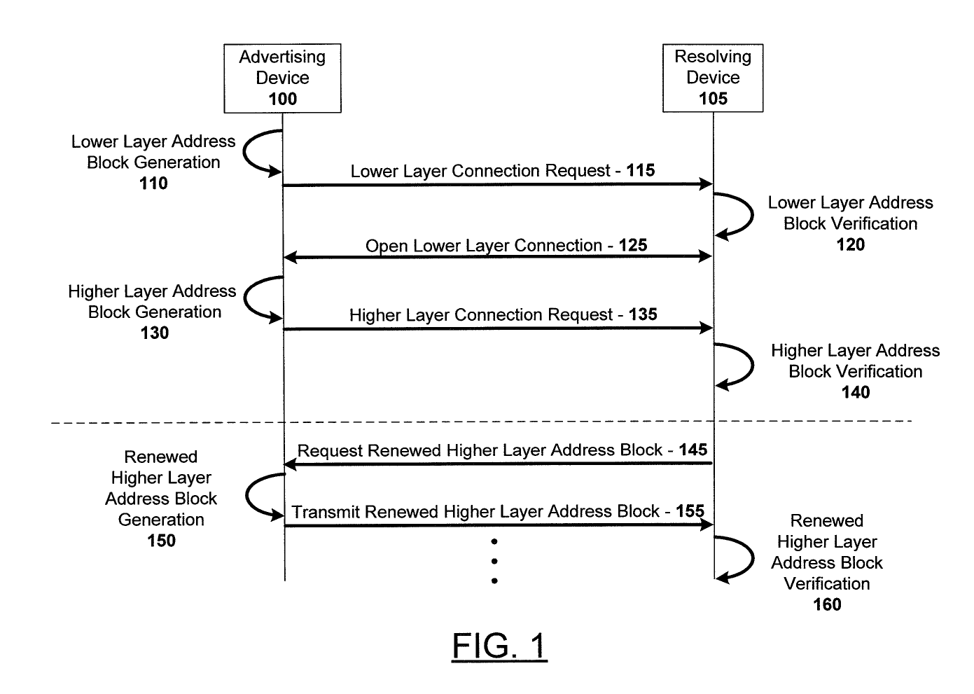

FIG. 1 depicts a signaling diagram detailing operations implemented in accordance with embodiments of the present invention. An advertising device 100 may be a device requesting a connection to a resolving device 105. The advertising device 100 and the resolving device 105 may be wired or wireless communications devices. The advertising device 100 may be requesting a peer-to-peer communications connection with the resolving device 105, and/or the advertising device may be requesting access to a network to which the resolving device 105 is connected. In this regard, the resolving device 105 may be an access point to a network for the advertising device 100.

To initiate a connection between the advertising device 100 and the resolving device 105, the advertising device may generate a lower layer address block at 110. The lower layer address block may be an address packet or a collection of addressing bits for establishing a connection at the lower layer based on an included address. In this regard, according to various embodiments of the present invention, an advertising device 100 may select an address to be used for establishing a connection at the lower layer. For example, the lower layer may be the link layer of the Open Systems Interconnection (OSI) protocol stack. In some example embodiments, the lower layer may be implemented in accordance with a communications standard such as an IEEE 802.11 standard.

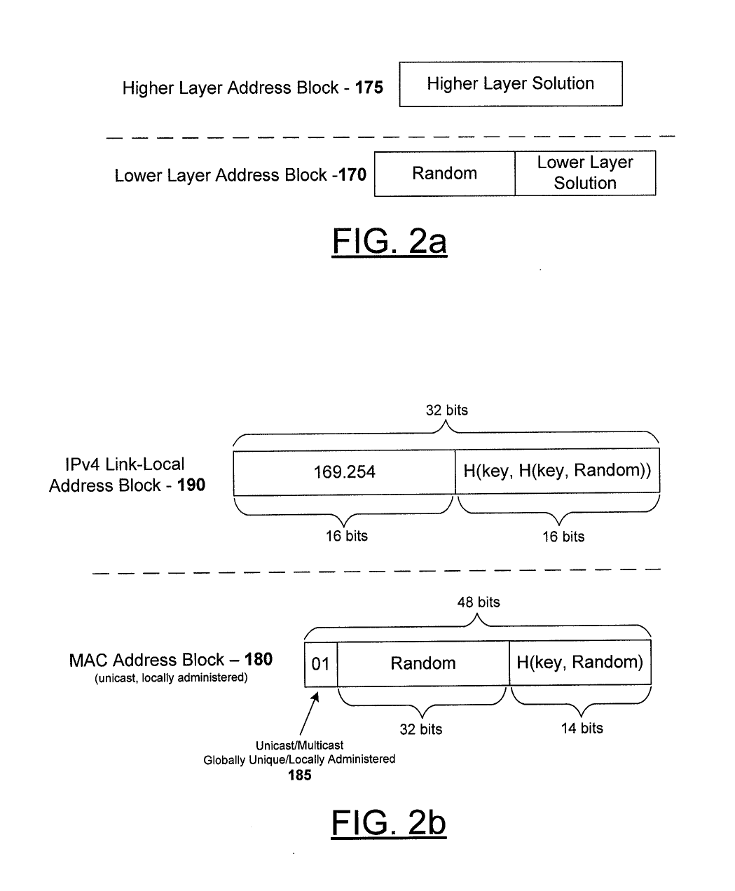

Referring to FIG. 2a, the lower layer address block 170 may be generated to include a random component and a lower layer solution component. The random component may include a random value determined via a random number or random value generator. Based on the type of generator, the random value may be a pseudo-random value.

As stated above, the lower layer address block 170 may also include a lower layer solution component. The lower layer solution component may also include a value. The value of the lower layer solution component may be determined via a one-way function. In this regard, the inputs to the one way function may be the random value taken from the random component, and a shared key. The shared key may have been acquired via any known mechanism, such that the advertising device 100 and the resolving device 105 have previously obtained, or have the ability to generate, the shared key.

The one-way function utilized in accordance with the various example embodiments described herein may be a keyed hash function. In this regard, the one-way function may generate a cryptographic message authorization code. Various example embodiments of the present invention may utilize a one-way function that generates, for example, a 128 bit result. Since, according to some example embodiments of the present invention, 128 bits may not be available, a selected portion of a result may be utilized for inclusion in the lower layer solution component. In this regard, a selected portion of a result of an evaluation of the one-way function may also be used in the higher layer solution component as further described below.

Accordingly, the make up of the lower layer address block 170 may appear to be completely random to a device that is not in possession of the shared key, and/or is unaware of the design of the lower layer address block 170. The design of the lower layer address block 170 in accordance with various example embodiments of the present invention therefore provides anonymity or address privacy to the advertising device 100 at the lower layer, while also allowing to the resolving device 105, which is in possession of the shared key, to identify the advertising device 100.

According to various example embodiments, the lower layer address block 170 may have a set number of bits based on the communications standard that is implemented on the lower layer. As such, a portion of the set number of bits may be allocated to the random component and a portion of the bit may be allocated to the lower layer solution component. In some example embodiments, half of the bits may be allocated to the random component and half of the bits may be allocated to the lower layer solution component. In the alternative, in some example embodiments, a larger number of bits may be allocated to the random component. Example embodiments that allocate a larger number of bits to the random component may reduce the probability of a collision, since the evaluation of the one-way function may result in increasingly distinct results, provided that the bit count of the solutions components in total (on all layers) equal or exceed the bit count of the random component.

However, given a set number of bits in the lower layer address block 170, when a larger number of bits are allocated to the random component, the lower layer solution component may have a corresponding smaller number of bits. Further, evaluation of the one-way function based on the random value and the shared key may find a result having any number of bits, possibly based on the one-way function. As such, a selected portion of the bits included in the result of the one-way function may input into the lower layer solution component. As will be described further below, a decrease in privacy associated with a less distinct lower layer solution component may be resolved at the higher layer where more bits may be available for assuring the identity of the advertising device 100.

A more specific example of a lower layer address block is depicted in FIG. 2b. The lower layer address block of FIG. 2b is a Media Access Control (MAC) address block 180 for link layer implementation. The MAC address block, comprising 48 bits, includes a 2 bit predefined portion 185 that is defined by the relevant 802.11 standard. The predefined portion 185 indicates that the MAC address block 180 is unicast and locally administered based on the 802.11 standard and the values “01” being the respective bits. The remainder of the address block (46 bits) may be utilized in accordance with embodiments of the present invention for implementing address privacy. In this regard, the random component may be defined to include a 32 bit random value. The lower layer solution component may be defined to be a portion (in this example a 14 bit portion) of a result of a one-way function having the shared key and the random value as inputs. The result of the one-way function may be written as H(key, Random), where H is the one-way function, key is the shared key, and Random is the random value.

Referring again to FIG, 1, the advertising device 100 may transmit a lower layer connection request including the lower layer address block to the resolving device 105 at 115. The resolving device 105 may receive the lower layer address block and perform a verification of the lower layer address block at 120 to identify the advertising device 100. The resolving device 105 may perform an evaluation of the one-way function used to generate the lower layer solution component of the lower layer address block. The resolving device 105 may be configured to obtain the random value from the random component and apply the random value, together with the shared key, to the one-way function to determine a result. The determined result, or a portion thereof, may be compared with the lower layer solution component. If a match is found, the lower layer address block may be considered verified and a lower layer connection between the advertising device 100 and the resolving device 105 may be established at 125. If a match is not found, the lower layer address block may be discarded and no action need be taken, or a renewed lower layer address block may be requested by the resolving device 105 from the advertising device 100.

In some instances, the resolving device 105 may identify a match, but also identify that a collision has occurred with respect to the lower layer address block. A collision may occur when two advertising devices 100 generate an identical lower layer address block. In the event of a collision at the lower layer, the resolving device 105 may request a second lower layer address block from the advertising device 100. The second lower layer address block may include a lower layer solution component that is a result of a recursive evaluation of the one-way function using the same random value from the first lower layer address block. In this regard, the one-way function may be written as H(key, H(key, Random)). To implement the recursive evaluation of the one-way function the advertising device 100 and the resolving device 105 may store the prior result of an evaluation of the one-way function for subsequent use to determine recursive results.

The advertising device 100 may also generate a higher layer address block at 130 to initiate a connection between the advertising device 100 and the resolving device 105 at the higher layer. The higher layer address block may be an address packet or a collection of addressing bits for establishing a connection at the higher layer based on an included address. In this regard, according to various embodiments of the present invention, an advertising device 100 may select an address to be used for establishing a connection at the higher layer. For example, the higher layer may be the network layer of the OSI protocol stack. In some example embodiments, the higher layer may be implemented in accordance with a communications standard such as an Internet Protocol (IP) standard.

Referring to FIG. 2a, the higher layer address block 175 may be generated to include a higher layer solution component. The higher layer solution component may include a value. The value of the higher layer solution component may be determined via a one-way function. In this regard, the inputs to the one-way function may be the random value taken from the random component of a received lower layer address block and the shared key.

Similar to the lower layer address block, the make up of the higher layer address block 175 may appear to be completely random to a device that is not in possession of the shared key, and/or is unaware of the design of the higher layer address block 175. The design of the higher layer address block 175, in accordance with various example embodiments of the present invention, therefore provides anonymity or address privacy to the advertising device 100 at the higher layer, while also allowing the resolving device 105, which is in possession of the shared key, to identify the advertising device 100.

According to various example embodiments, the higher layer address block 175 may have a set number of bits based on the communications standard that is implemented on the higher layer. As such, a portion of the set number of bits may be allocated to the higher layer solution component.

A more specific example of a higher layer address block is depicted in FIG. 2b. The higher layer address block of FIG. 2b is an Internet Protocol version 4 (IPv4) link-local address block 190 for network layer implementation. The IPv4 link-local address block 190, comprising 32 bits, includes a 16 bit predefined portion that is static for link-local addressing. The static 16 bit portion is defined by the standard as 169.254. The remainder of the address block (16 bits) may be utilized in accordance with embodiments of the present invention for implementing address privacy. In this regard, the higher layer solution component may be defined to be a portion (in this example a 16 bit portion) of a result of a one-way function having the shared key and the random value as inputs. In accordance with the example embodiment of FIG. 2b, the higher layer solution component may be a 16 bit portion of the result of the one-way function defined as H(key, H(key, Random)).

In this regard, the higher layer solution component may be determined via a recursive evaluation of the one-way function using the random value from the lower layer address block and the shared key as inputs. According to various embodiments, to generate the higher layer solution portion, the advertising device 100 may store a previous result of an evaluation of the one-way function for use in a recursive manner in further evaluations.

Referring again to FIG, 1, the advertising device 100 may transmit a higher layer connection request including the higher layer address block to the resolving device 105 at 135. The resolving device 105 may receive the higher layer address block and perform a verification of the higher layer address block at 140 to identify the advertising device 100 at the higher layer. The resolving device 105 may perform an evaluation of the one-way function used to generate the higher layer solution component of the higher layer address block. The resolving device 105 may be configured to obtain the random value from the random component of the lower layer address block and apply the random value, together with the shared key, to the one-way function to determine a result. According to some embodiments, the resolving device may apply a prior result of an evaluation of the one-way function in a recursive manner to determine a result of the one-way function for use in verification at the higher layer. The determined result, or a portion thereof, may be compared with the higher layer solution component. If a match is found, the higher layer address block may be verified and a higher layer connection between the advertising device 100 and the resolving device 105 may be established. If a match is not found, the higher layer address block may be discarded and no action need be taken, or a renewed higher layer address block may be requested by the resolving device 105 from the advertising device 100 at 145.

In addition to requesting a renewed higher layer address block due to a mismatch, the resolving device 105 may also request a renewed higher layer address block in response to a collision at the higher layer, to further verify the identification of the advertising device 100, or to increase anonymity by regularly or irregularly changing the higher layer address for the advertising device 100. Further, a renewed higher layer address block may be requested as part of a try procedure or a back-off procedure according to various communications standards. The request for a renewed higher layer address block may be performed via an Address Resolution Protocol (ARP) message as shown in Request for Comment (RFC) 826 or Neighbor Discovery Protocol (NDP) message as shown in RFC 4861.

Regardless of the impetus, the advertising device 100 may respond by generating a renewed higher layer address block. The renewed higher layer solution component may also be determined via the one-way function. In this regard, the inputs to the one way function may be the random value taken from the random component of a received lower layer address block and the shared key. For the renewed higher layer solution component, a recursive evaluation of the one-way function may be implemented to determine a result for inclusion in the higher layer solution component. For example, the recursive result for the renewed higher layer solution component may be written as H(key, H(key, H(key, Random))).

According to various example embodiments, additional renewed higher layer address blocks may be requested, generated, and verified to further assure the identity of the advertising device 100, or for other purposes. In this regard, each time a renewed higher layer address block is generated an additional iterative recursive evaluation may be performed for generation and verification of the renewed higher layer address block. In this manner, according to various example embodiments, a degree of anonymity may be maintained, or even increased, while also increasing the assurance of the identity of the advertising device. Further, renewed address blocks may also be implemented at the lower layer in a similar manner. In some instances, however, verification at the higher layer may be unaware of recursive evaluations that occurred at the lower layer, and vice versa. As a result, the resolving device 105 may be configured to either share the results of the recursive evaluation between layer resolutions or calculate one or more next recursive results in order to determine a current recursive evaluation result.

FIG. 1 describes an example embodiment where a lower layer connection is resolved prior to the higher layer being resolved. However, example embodiments of the present invention are also applicable where resolution of the lower layer and the higher layer are performed in parallel.

According to various example embodiments of the present invention, various strategies may be implemented for address privacy based on how the bits within the address blocks are allocated and how addressing at the higher layer is handled. In this regard, as described above, a larger number of bits may be allocated to the random value in the lower layer address block 170. This may result in a lesser number of bits being allocated to the lower layer solution component. As such, a lesser degree of privacy may be realized at the lower layer due to the possibilities of results for the lower layer solution being less distinct. However, via one or more implementations of renewed higher layer address blocks, a resolving device 105 may increasingly assure the identity of the advertising device 100 at the higher layer, while the advertising device 100 continues to maintain anonymity with respect to devices that are not in possession of the shared key for identity resolving.

While some of the example embodiments of the present invention described above are directed to implementation within an IPv4 environment, it is contemplated that aspects of the present invention may also be implemented in IPv6 environments in a similar manner. Further, the lower layer and the higher layer may be layers of any communications protocol stack, and therefore the example embodiments described herein may be broadly applied and are not limited to the environments in which they are described herein. For instance, example embodiments of the present invention may be implemented in any type of communications network including ad-hoc wireless local area networks (WLANs) and/or Bluetooth ultra low power (ULP) networks. Example embodiments of lower layer address blocks include Media Access Control (MAC) addresses, Bluetooth Device addresses (BD_ADDR), Extended Unique Identifier (EUI) EUI-48 and EUI-64.

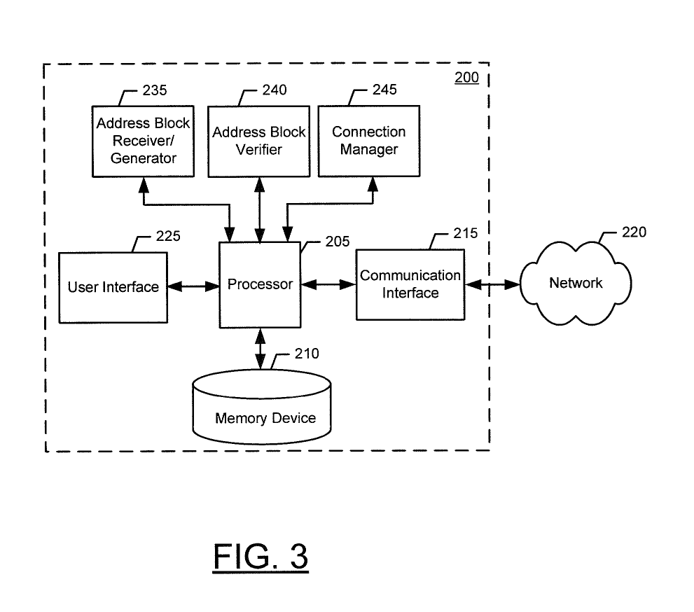

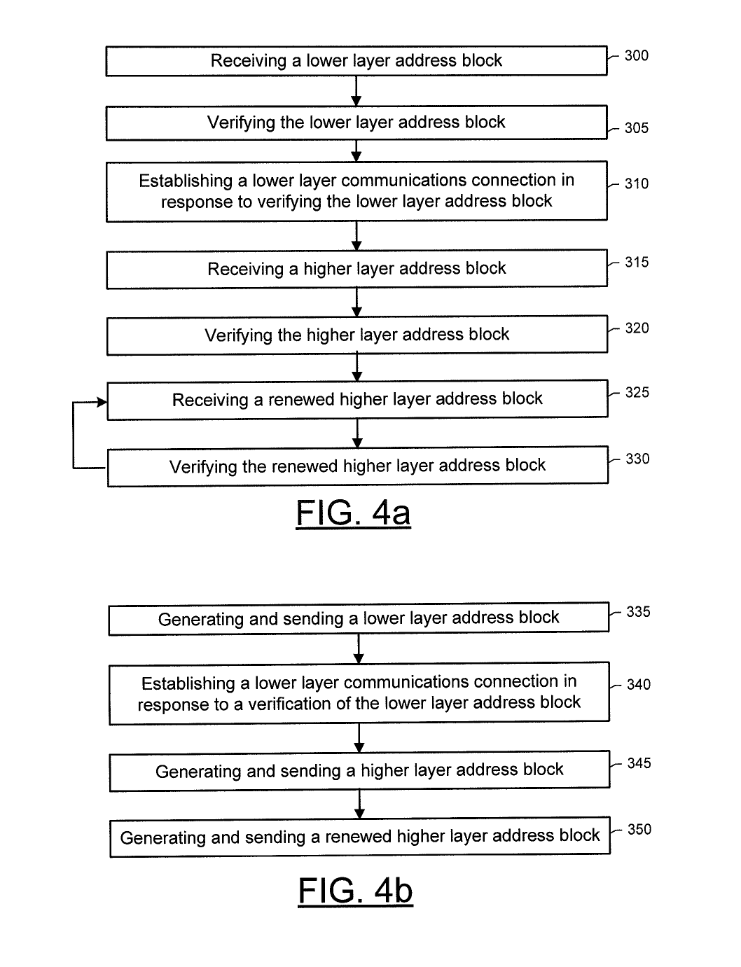

The description provided above and generally herein illustrates example methods, apparatuses, and computer program products for implementing address privacy. FIG. 3 illustrates another example embodiment of the present invention in the form of an example apparatus 200 that is configured to perform various aspects of the present invention as described herein. The example apparatus 200 may be configured to operate in accordance with the description of the advertising device 100 and/or the resolving device 105 described above. The example apparatus 200 may be configured to perform example methods of the present invention, such as those described with respect to FIGS. 1, 4a, and 4b.

In some example embodiments, the apparatus 200 may, but need not, be embodied as, or included as a component of, a communications device with wired or wireless communications capabilities. Some examples of the apparatus 200, or devices that may include the apparatus 200, may include a computer, a server, a network entity, a mobile terminal such as a mobile telephone, a portable digital assistant (PDA), a pager, a mobile television, a gaming device, a mobile computer, a laptop computer, a camera, a video recorder, an audio/video player, a radio, and/or a global positioning system (GPS) device, or any combination of the aforementioned, or the like. Further, the example apparatus 200 may be configured to implement various aspects of the present invention as described herein including, for example, various example methods of the present invention, where the example methods may be implemented by means of a hardware configured processor or a processor configured through the execution of instructions stored in a computer-readable storage medium, or the like.

The example apparatus 200 may include or otherwise be in communication with a processor 205, a memory device 210, a communications interface 215, an address block receiver/generator 235, an address block verifier 240, and/or a connection manager 245. In some embodiments, the example apparatus 200 may optionally include a user interface 225. The processor 205 may be embodied as various means implementing various functionality of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. In some example embodiments, the processor 205 may, but need not, include one or more accompanying digital signal processors. In some example embodiments, the processor 205 may be configured to execute instructions stored in the memory device 210 or instructions otherwise accessible to the processor 205. As such, whether configured by hardware or via instructions stored on a computer-readable storage medium, or by a combination thereof, the processor 205 may represent an entity capable of performing operations according to embodiments of the present invention while configured accordingly. Thus, for example, when the processor 205 is embodied as an ASIC, FPGA or the like, the processor 205 may be specifically configured hardware for conducting the operations described herein. Alternatively, when the processor 205 is embodied as an executor of instructions stored on a computer-readable storage medium, the instructions may specifically configure the processor 205 to perform the algorithms and operations described herein. However, in some cases, the processor 205 may be a processor of a specific device (e.g., a mobile terminal) configured for employing example embodiments of the present invention by further configuration of the processor 205 via executed instructions for performing the algorithms and operations described herein.

The memory device 210 may be one or more computer-readable storage media that may include volatile and/or non-volatile memory. For example, memory device 210 may include Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, or the like for enabling the processor 205 and the example apparatus 200 to carry out various functions in accordance with example embodiments of the present invention. For example, the memory device 210 could be configured to buffer input data for processing by the processor 205. Additionally, or alternatively, the memory device 210 may be configured to store instructions for execution by the processor 205.

The communication interface 215 may be any device or means embodied in either hardware, a computer program product, or a combination of hardware and a computer program product that is configured to receive and/or transmit data from/to a network and/or any other device or module in communication with the example apparatus 200. Processor 205 may also be configured to facilitate communications via the communications interface by, for example, controlling hardware included within the communications interface 215. In this regard, the communication interface 215 may include, for example, one or more antennas, a transmitter, a receiver, a transceiver and/or supporting hardware, including a processor for enabling communications with network 220. Via the communication interface 215 and the network 220, the example apparatus 200 may communicate with various other network entities in a peer-to-peer fashion or via indirect communications via a base station, access point, server, gateway, router, or the like.

The communications interface 215 may be configured to provide for communications in accordance with any wired or wireless communication standard. The communications interface 215 may be configured to support communications in multiple antenna environments, such as multiple input multiple output (MIMO) environments. Further, the communications interface 215 may be configured to support orthogonal frequency division multiplexed (OFDM) signaling. In some example embodiments, the communications interface 215 may be configured to communicate in accordance with various techniques, such as, second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 215 may also be configured to support communications at the network layer, possibly via Internet Protocol (IP).

The user interface 225 may be in communication with the processor 205 to receive user input via the user interface 225 and/or to present output to a user as, for example, audible, visual, mechanical or other output indications. The user interface 225 may include, for example, a keyboard, a mouse, a joystick, a touch screen display, a microphone, a speaker, or other input/output mechanisms.

The address block receiver/generator 235, the address block verifier 240, and the connection manager 245 of example apparatus 200 may be any means or device embodied, partially or wholly, in hardware, a computer program product, or a combination of hardware and a computer program product, such as processor 205 implementing stored instructions to configure the example apparatus 200, or a hardware configured processor 205, that is configured to carry out the functions of the address block receiver/generator 235, the address block verifier 240, and/or the connection manager 245 as described herein. In an example embodiment, the processor 205 includes, or controls, the address block receiver/generator 235, the address block verifier 240, and/or the connection manager 245. The address block receiver/generator 235, the address block verifier 240, and/or the connection manager 245 may be, partially or wholly, embodied as processors similar to, but separate from processor 205. In this regard, the address block receiver/generator 235, the address block verifier 240, and/or the connection manager 245 may be in communication with the processor 205. In various example embodiments, the address block receiver/generator 235, the address block verifier 240, and/or the connection manager 245 may, partially or wholly, reside on differing apparatuses such that some or all of the functionality of the address block receiver/generator 235, the address block verifier 240, and/or the connection manager 245 may be performed by a first apparatus, and the remainder of the functionality of the address block receiver/generator 235, the address block verifier 240, and/or the connection manager 245 may be performed by one or more other apparatuses.

The address block receiver/generator 235 may be configured to cause the example apparatus 200 to perform various functionality. In this regard, the address block receiver/generator 235 may be configured to receive and/or generate a lower layer address block. With regard to whether the address block receiver/generator 235 is receiving or generating an address block or receiving an address block, when the apparatus 200 is taking the role of a resolving device, the address block receiver/generator 235 may be configured to receive the address block, but when the apparatus 200 is taking the role of an advertising device, the address block receiver/generator 235 may be configured to generate the address block.

Whether generated by the address block receiver/generator 235 or received by the address block receiver/generator 235 from an advertising device, the lower layer address block may include a random component and a lower layer solution component. The random component may include a random value and the lower layer solution component may be based at least in part on the random value and a shared key. In this regard, according to various example embodiments, the address block receiver/generator 235 may be configured to generate the lower layer address block by determining a random value and determining a result of a one-way function using the random value and a shared key.

Further, the address block receiver/generator 235 may be configured to receive and/or generate a higher layer address block. Whether generated by the address block receiver/generator 235 or received by the address block receiver/generator 235 from an advertising device, the higher layer address block may include a higher layer solution component. The higher layer solution component may be based at least in part on the random value and a shared key. In some example embodiments, the higher layer solution component may include a recursive result of an evaluation of a one-way function using the random value and the shared key as inputs.

The address block receiver/generator 235 may also be configured to generate and/or receive a renewed higher layer address block. The renewed higher layer address block may include a renewed higher layer solution component. The renewed higher layer solution component may be based at least in part on the result of an implementation of the one-way function and a shared key. According to various example embodiments, the renewed higher layer solution component may include a recursive result of the one-way function. The address block receiver/generator 235 may also be configured to generate and/or receive renewed lower layer address blocks in a similar manner.

Further, according to some example embodiments, the address block receiver/generator 235 may be configured to receive and/or generate the lower layer address block as a Media Access Control (MAC) address. The address block receiver/generator 235 may, additionally or alternatively, be configured to receive and/or generate the higher layer address block as an Internet Protocol (IP) link-local address.

The address block verifier 240 may be configured to cause the example apparatus 200 to perform various functionality. The address block verifier 240 may be configured to verify the identity of an advertising device by verifying a lower layer and/or a higher layer address block received from the advertising device. In this regard, the address block verifier 240 may be configured to verify the lower layer address block via a random value received in the lower layer address block and a shared key. The address block verifier 240 may also be configured to verify a higher layer address block via the random value, or a result of a recursive evaluation of a one-way function using the random value, and a shared key.

In this regard, the address block verifier 240 may be configured to verify the lower layer address block by determining a result of a first implementation of a one-way function based at least in part on the random value and the shared key. The address block verifier 240 may then be configured to compare the result of the first implementation of the one-way function to the lower layer solution component for verification purposes. Further, the address block verifier 240 may be configured to verify a higher layer address block by determining a result of a second implementation of the one-way function based at least in part on the result of the first implementation of the one-way function and the shared key. The address block verifier 240 may be additionally configured to compare the result of the second implementation of the one-way function to the higher layer solution component for verification purposes.

In some example embodiments, the address block verifier 240 may also be configured to verify a renewed higher layer address block by determining a result of a third implementation of the one-way function based at least in part on the result of the second implementation of the one-way function and the shared key. The address block verifier 240 may then be configured to compare the result of the third implementation of the one-way function to the renewed higher layer solution component to increase a relative level of verification or to increasingly assure the identify of the advertising device. According to various example embodiments, the second and third results of the evaluation of the one-way function may be recursive results. Further, the address block verifier 240 may be configured to verify renewed lower level address blocks in a similar manner.

The connection manager 245 may be configured to cause the example apparatus 200 to perform various functionality. The connection manager 245 may be optionally configured to establish lower layer and/or higher layer connections based on the verifications determined by the address block verifier 240. In this regard, the connection manager 245 may be configured to establish a lower layer communications connection with an advertising device in response to verifying the lower layer address block. In this regard, establishing a lower layer communications connection may include establishing a communications connection at the link layer. Further, the connection manager 245 may be optionally configured to establish a higher layer communications connection in response to verifying the higher layer address block. In this regard, establishing a higher layer communications connection may include establishing a communications connection at the network layer.

FIGS. 1, 4a, and 4b illustrate example flowcharts of a system, method, and computer program product according to example embodiments of the invention. It will be understood that each block, step, or operation of the flowcharts, and/or combinations of blocks, steps, or operations in the flowcharts, can be implemented by various means. Means for implementing the blocks, steps, or operations of the flowcharts, combinations of the blocks, steps or operations in the flowchart or other functionality of example embodiments of the invention described herein may include hardware, and/or a computer program product including a computer-readable storage medium having one or more computer program code instructions, program instructions, or executable computer-readable program code instructions stored therein. In this regard, program code instructions may be stored on a memory device, such as memory device 210, of an example apparatus, such as example apparatus 200, and executed by a processor, such as the processor 205. As will be appreciated, any such program code instructions may be loaded onto a computer or other programmable apparatus (e.g., processor 205, memory device 210) from a computer-readable storage medium to produce a particular machine, such that the particular machine becomes a means for implementing the functions specified in the flowcharts' block(s), step(s), or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s), step(s), or operation(s). The program code instructions may be retrieved from a computer-readable storage medium and loaded into a computer, processor, or other programmable apparatus to configure the computer, processor, or other programmable apparatus to execute operational steps to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide steps for implementing the functions specified in the flowcharts' block(s), step(s), or operation(s).

Accordingly, execution of instructions associated with the blocks, steps, or operations of the flowchart by a processor, or storage of instructions associated with the blocks, steps, or operations of the flowcharts in a computer-readable storage medium, support combinations of steps for performing the specified functions. It will also be understood that one or more blocks, steps, or operations of the flowcharts, and combinations of blocks, steps, or operations in the flowcharts, may be implemented by special purpose hardware-based computer systems and/or processors which perform the specified functions or steps, or combinations of special purpose hardware and program code instructions.

FIG. 4a depicts an example method for implementing address privacy according to various embodiments of the present invention. The example method of FIG. 4a may be performed by a resolving device. The example method includes receiving a lower layer address block from an advertising device at 300. The lower layer address block may include a random component and a lower layer, solution component. The random component may include a random value and the lower layer solution component may be based at least in part on the random value and a shared key. In some example embodiments, receiving the lower layer address block may include receiving the lower layer address block as a Media Access Control (MAC) address.

The example method may further include verifying the lower layer address block via the random value and the shared key at 305 and, according to some example embodiments, establishing a lower layer communications connection with the advertising device in response to verifying the lower layer address block at 310. In some example embodiments, verifying the lower layer address block may include verifying the lower layer address block by determining a result of a one-way function having inputs of the random value and the shared key. In some example embodiments, verifying the lower layer address block may include verifying the lower layer address block by determining a result of a first implementation of a one-way function based at least in part on the random value and the shared key, and comparing the result of the first implementation of the one-way function to the lower layer solution component. In some example embodiments, establishing a lower layer communications connection may include establishing a link layer communications connection.

The example method may further include receiving a higher layer address block from the advertising device at 315. The higher layer address block may include a higher layer solution component. The higher layer solution component may be based at least in part on the random value and a shared key. In some example embodiments, receiving the higher layer address block may include receiving the higher layer address block as an Internet Protocol (IP) link-local address.

The example method may also include verifying the higher layer address block via the random value and the shared key at 320. In some example embodiments, verifying the higher layer address block may include verifying the higher layer address block by determining a result of a second implementation of the one-way function based at least in part on the result of the first implementation of the one-way function and the shared key, and comparing the result of the second implementation of the one-way function to the higher layer solution component. In some example embodiments, the example method may further include establishing a network layer communications connection in response to verifying the higher layer address block.

In some example embodiments, the example method may further include receiving a renewed higher layer address block from the advertising device at 325. The renewed higher layer address block may including a renewed higher layer solution component. The renewed higher layer solution component may be based at least in part on the result of the second implementation of the one-way function and a shared key. The example method may further include verifying the renewed higher layer address block at 330 by determining a result of a third implementation of the one-way function based at least in part on the result of the second implementation of the one-way function and the shared key. Verifying the renewed higher layer address block may include comparing the result of the third implementation of the one-way function to the renewed higher layer solution component. In some example embodiments, the operations associated with 325 and 330 may be repeated to increasingly assure the identity of the advertising device, while maintaining address privacy.

FIG. 4b depicts an example method for implementing address privacy according to various embodiments of the present invention. The method of FIG. 4b may be performed by an advertising device.

The example method of FIG. 4b includes generating and sending a lower layer address block to a resolving device at 335. The lower layer address block may include a random component and a lower layer solution component. The random component may include a random value and the lower layer solution component may be based at least in part on the random value and a shared key. In some example embodiments, generating the lower layer address block may include generating the lower layer address block as a Media Access Control (MAC) address.

The example method of FIG. 4b may further include establishing a lower layer communications connection with the resolving device in response to a verification of the lower layer address block at 340. In some example embodiments, establishing a lower layer communications connection may include establishing a link layer communications connection.

The example method may further include generating and sending a higher layer address block to the resolving device at 345. The higher layer address block may include a higher layer solution component. The higher layer solution component may be based at least in part on the random value and a shared key. In some example embodiments, receiving the higher layer address block may include receiving the higher layer address block as an Internet Protocol (IP) link-local address.

In some example embodiments, the example method may further include generating and sending one or more renewed higher layer address blocks to the resolving device at 350. The renewed higher layer address block may include a renewed higher layer solution component. The renewed higher layer solution component may be based at least in part on the result of the second implementation of the one-way function and a shared key.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1.-20. (canceled)

21. A method comprising:
receiving a lower layer address block from an advertising device, the lower layer address block including a random component and a lower layer solution component, the random component including a random value and the lower layer solution component being based at least in part on the random value and a shared key;
verifying, via a processor, the lower layer address block via the random value and the shared key;
receiving a higher layer address block from the advertising device, the higher layer address block including a higher layer solution component, the higher layer solution component based at least in part on the random value and a shared key; and
verifying the higher layer address block via the random value and the shared key.

22. The method of claim 21, wherein verifying the lower layer address block includes verifying the lower layer address block by determining a result of a one-way function having inputs of the random value and the shared key.

23. The method of claim 21, wherein verifying the lower layer address block includes verifying the lower layer address block by determining a result of a first implementation of a one-way function based at least in part on the random value and the shared key, and comparing the result of the first implementation of the one-way function to the lower layer solution component; and
wherein verifying the higher layer address block includes verifying the higher layer address block by determining a result of a second implementation of the one-way function based at least in part on the result of the first implementation of the one-way function and the shared key, and comparing the result of the second implementation of the one-way function to the higher layer solution component.

24. The method of claim 23, further comprising:
receiving a renewed higher layer address block from the advertising device, the renewed higher layer address block including a renewed higher layer solution component, the renewed higher layer solution component based at least in part on the result of the second implementation of the one-way function and a shared key; and
verifying the renewed higher layer address block by determining a result of a third implementation of the one-way function based at least in part on the result of the second implementation of the one-way function and the shared key, and comparing the result of the third implementation of the one-way function to the renewed higher layer solution component.

25. The method of claim 21 further comprising:
establishing a lower layer communications connection in response to verifying the lower layer address block, the lower layer communications connection including a link layer communications connection; and
establishing a higher layer communications connection in response to verifying the lower layer address block, the higher layer communications connection including a network layer communications connection.

26. The method of claim 21, wherein receiving the lower layer address block includes receiving the lower layer address block as a media access control address, and wherein receiving the higher layer address block includes receiving the higher layer address block as an internet protocol link-local address.

27. An apparatus comprising a processor and a memory storing instructions that, in response to execution of the instructions by the processor, cause the apparatus to at least:
receive a lower layer address block from an advertising device, the lower layer address block including a random component and a lower layer solution component, the random component including a random value and the lower layer solution component being based at least in part on the random value and a shared key;
verify the lower layer address block via the random value and the shared key;
receive a higher layer address block from the advertising device, the higher layer address block including a higher layer solution component, the higher layer solution component based at least in part on the random value and a shared key; and
verify the higher layer address block via the random value and the shared key.

28. The apparatus of claim 27, wherein the apparatus caused to verify the lower layer address block includes being caused to verify the lower layer address block by determining a result of a one-way function having inputs of the random value and the shared key.

29. The apparatus of claim 27, wherein the apparatus caused to verify the lower layer address block includes being caused to:
verify the lower layer address block by determining a result of a first implementation of a one-way function based at least in part on the random value and the shared key, and
compare the result of the first implementation of the one-way function to the lower layer solution component; and
wherein the apparatus caused to verify the higher layer address block includes being caused to:
verify the higher layer address block by determining a result of a second implementation of the one-way function based at least in part on the result of the first implementation of the one-way function and the shared key, and
compare the result of the second implementation of the one-way function to the higher layer solution component.

30. The apparatus of claim 29, wherein, in response to execution of the instructions by the processor, the apparatus is further caused to at least:
receive a renewed higher layer address block from the advertising device, the renewed higher layer address block including a renewed higher layer solution component, the renewed higher layer solution component based at least in part on the result of the second implementation of the one-way function and a shared key; and
verify the renewed higher layer address block by determining a result of a third implementation of the one-way function based at least in part on the result of the second implementation of the one-way function and the shared key, and comparing the result of the third implementation of the one-way function to the renewed higher layer solution component.

31. The apparatus of claim 27, wherein, in response to execution of the instructions by the processor, the apparatus is further caused to at least:
establish a lower layer communications connection in response to verifying the lower layer address block, the lower layer communications connection including a link layer communications connection; and
establish a higher layer communications connection in response to verifying the lower layer address block, the higher layer communications connection including a network layer communications connection.

32. The apparatus of claim 27, wherein the apparatus caused to receive the lower layer address block includes being caused to receive the lower layer address block as a media access control address, and wherein the apparatus caused to receive the higher layer address block includes being caused to receive the higher layer address block as an internet protocol link-local address.

33. A computer program product comprising at least one computer-readable storage medium having executable computer-readable program code instructions stored therein, the computer-readable program code instructions configured to:
receive a lower layer address block from an advertising device, the lower layer address block including a random component and a lower layer solution component, the random component including a random value and the lower layer solution component being based at least in part on the random value and a shared key;
verify the lower layer address block via the random value and the shared key;
receive a higher layer address block from the advertising device, the higher layer address block including a higher layer solution component, the higher layer solution component based at least in part on the random value and a shared key; and
verify the higher layer address block via the random value and the shared key.

34. The computer program product of claim 33, wherein the computer-readable program code instructions configured to verify the lower layer address block include being configured to verify the lower layer address block by determining a result of a one-way function having inputs of the random value and the shared key.

35. The computer program product of claim 33, wherein the computer-readable program code instructions configured to verify the lower layer address block include being configured to:
verify the lower layer address block by determining a result of a first implementation of a one-way function based at least in part on the random value and the shared key, and
compare the result of the first implementation of the one-way function to the lower layer solution component; and
wherein the computer-readable program code instructions configured to verify the higher layer address block include being configured to:
verify the higher layer address block by determining a result of a second implementation of the one-way function based at least in part on the result of the first implementation of the one-way function and the shared key, and
compare the result of the second implementation of the one-way function to the higher layer solution component.

36. The computer program product of claim 35, wherein the computer-readable program code instructions are further configured to:
receive a renewed higher layer address block from the advertising device, the renewed higher layer address block including a renewed higher layer solution component, the renewed higher layer solution component based at least in part on the result of the second implementation of the one-way function and a shared key; and
verify the renewed higher layer address block by determining a result of a third implementation of the one-way function based at least in part on the result of the second implementation of the one-way function and the shared key, and comparing the result of the third implementation of the one-way function to the renewed higher layer solution component.

37. The computer program product of claim 33, wherein the computer-readable program code instructions are further configured to:
establish a lower layer communications connection in response to verifying the lower layer address block, the lower layer communications connection including a link layer communications connection; and
establish a higher layer communications connection in response to verifying the lower layer address block, the higher layer communications connection including a network layer communications connection.

38. The computer program product of claim 33, wherein the computer-readable program code instructions configured to receive the lower layer address block include being configured to receive the lower layer address block as a media access control address, and wherein the computer-readable program code instructions configured to receive the higher layer address block include being configured to receive the higher layer address block as an internet protocol link-local address.
